(19) United States
(12) Patent Application Publication
(10) Pub. No.: US 2021/0156321 A1
(43) Pub. Date: May 27, 2021

(54) DIESEL METHANOL COMBINED COMBUSTION ENGINE AND CONTROL METHOD THEREOF

(71) Applicant: TIANJIN UNIVERSITY, Tianjin (CN)

(72) Inventors: Chunde YAO, Tianjin (CN); Anren YAO, Tianjin (CN); Bin WANG, Tianjin (CN); Taoyang WU, Tianjin (CN); Jiangtao HU, Tianjin (CN); Chao CHEN, Tianjin (CN); Jian GAO, Tianjin (CN)

(21) Appl. No.: 17/163,550

(22) Filed: Jan. 31, 2021

Related U.S. Application Data
(63) Continuation of application No. PCT/CN2019/120937, filed on Nov. 26, 2019.

(30) Foreign Application Priority Data
Aug. 9, 2019 (CN) 201910736114.5

(51) Int. Cl. F02D 19/06; F02D 19/08; F01N 3/20; F01N 3/035; F02D 41/38

(52) U.S. Cl. CPC F02D 19/0615; F02D 19/0649; F02D 19/081; F01N 2250/02; F01N 3/035; F02D 41/3827; F01N 3/208

(57) ABSTRACT

The present invention relates to a diesel methanol combined combustion engine, comprising: a diesel engine, a methanol injection system, a methanol electronic control unit, a methanol supply system and a post-processor combination. The methanol injection system is on an inlet pipe of the diesel engine, which is connected with the methanol electronic control unit and the methanol supply system. The Methanol specific SCR system and the DPF are controlled by the methanol electronic control unit. The post-processor combination is installed on the exhaust pipe. The DMCC technology can achieve high efficiency combustion of the diesel engine, in particular, improving the thermal efficiency of engines especially under medium and full load conditions, and reducing NOx and soot emissions without urea assistance. The invention also relates to a control method of the diesel methanol combined combustion engine.

### CROSS-REFERENCE TO RELATED APPLICATIONS

This Application is a bypass continuation application of PCT/CN2019/120937. This application claims priorities from PCT Application No. PCT/CN2019/120937, filed Nov. 26, 2019, and from the Chinese patent application 201910736114.5 filed Aug. 9, 2018, the content of which is incorporated herein in the entirety by reference.

### TECHNICAL FIELD

The present invention relates to the technical field of engine and in particular to a diesel methanol combined combustion engine and control method thereof.

### BACKGROUND OF THE PRESENT INVENTION

Methanol vehicles are divided into spark ignition (SI) methanol passenger vehicles/commercial vehicles and compression ignition (CI) methanol vehicles, wherein the technical route adopted by SI methanol passenger vehicles and commercial vehicles is similar to that of traditional SI gasoline engine. However, it is difficult to start the engine cold because of the high latent of methanol vaporization, so that the gasoline is needed to start the engine. After the engine is fully warmed-up, methanol fuel is used exclusively to form a homogeneous mixture inside the intake manifold, and then the premixed mixture is ignited by the spark plug in cylinder. The technical route adopted by SI methanol commercial vehicles is similar to that adopted by passenger vehicles. The technical route mainly adopted by CI methanol commercial vehicles is a diesel methanol combined combustion technology. Due to the high auto-ignition temperature of methanol and cannot easily be ignited by compression at most operating conditions in a compression ignition engine, diesel is needed to ignite the methanol premixed mixture. The pure diesel working mode is adopted when the engine is in the starting and idling conditions, and the diesel methanol combined combustion mode is adopted when cooling water temperature and other conditions meet the requirements, which is called DMCC (diesel methanol combined combustion) mode for short.

At present, most of the heavy-duty diesel engines that meet the “Emission Standard for Motor Vehicles” (CHN-V and above) in China adopt a post-processor combination of the diesel oxidation-catalytic converter (DOC), urea selective catalytic reduction system (urea SCR) and diesel particulate filter (DPF). The application of the post-processor combination requires injection of urea in the exhaust pipe continuously, which will increase the use cost of users. Meanwhile, in order to regenerate DPF, diesel injection is required in the exhaust pipe to oxidize the carbon particles collected inside DPF, which will cause internal thermal failures of DPF and increase the fuel cost of users.

The diesel methanol combined combustion technology has the characteristics of higher emissions of carbon monoxide and unburned hydrocarbon, and the proportion of nitrogen dioxide emissions to nitrogen oxide emissions is also higher, nitrogen dioxide is the critical radicals of DPF passive regeneration. Chinese patent CN 110454289 discloses a diesel-methanol dual-fuel engine for diesel combustion engine, but this engine is based on a diesel engine with a mechanical pump, and required to install several sensors so as to read engine signals. The present heavy road vehicles are equipped with diesel engines having the high-pressure common-rail ECU. In order to further expand the application of diesel-methanol dual-fuel technology in high-pressure common-rail diesel engines, it is necessary to develop new diesel-methanol combined combustion engines based on the prior art.

Therefore, based on above reasons, it is necessary to develop a technical solution that can solve the problem of excessive emissions of smoke (PM) of heavy-duty vehicle with low emission standards, and at the same time can reduce the fuel cost of vehicle owners significantly.

### SUMMARY OF THE PRESENT INVENTION

The purpose of the present invention is to overcome the deficiencies of the prior art, and provide a diesel methanol combined combustion engine and control method thereof.

For this purpose, the following technical solutions are employed in the present invention.

A diesel methanol combined combustion (DMCC) engine, includes a diesel engine and post-processor combination; the post-processor combination includes: a methanol specific SCR system, a diesel particulate filter (DPF) and a diesel oxidation-catalytic converter (DOC); the methanol specific SCR system and the DPF are controlled by a methanol electronic control unit; the post-processor combination is installed on an exhaust pipe of the diesel engine, and the connection sequence of the post-processor combination on the exhaust pipe is the methanol specific SCR system, the DPF and the DOC sequentially; wherein, the diesel engine is equipped with a high pressure common-rail electronic control unit (ECU), the diesel methanol combined combustion (DMCC) engine also includes: a methanol injection system, a methanol electronic control unit (hereinafter referred to as ECU), a methanol supply system; by using an On Board Diagnosis (OBD) system of the vehicle to connect the diesel engine and the methanol system including the methanol injection system, a methanol ECU and the methanol supply system, to realize the coordinated work therebetween.

The methanol ECU and the methanol supply system are respectively connected with the methanol injection system.

Further, the methanol ECU is connected to the methanol injection system, the methanol ECU is provided with an CAN interface, which is connectable to the high pressure common-rail ECU of the diesel engine, so that the methanol ECU acquires parameters from the CAN messages of the high pressure common-rail ECU; the methanol ECU calculates methanol injection volume according to working condition of the diesel engine, the methanol supply system continuously supplies methanol at a certain pressure to the methanol injection system; wherein the acquired parameter includes speed signal, accelerator pedal signal, cooling water temperature signal, and inlet temperature and pressure signal.

Further, the methanol injection system is installed on an intake pipe of the diesel engine after the engine intercooler, and the methanol injection system is composed of a methanol nozzle and a methanol injector.

Further, the methanol supply system includes: the methanol tank, a methanol pump strainer, a methanol level gauge, an electric methanol pump, a methanol filter, a methanol pressure regulating valve, a methanol distribution pipe, a methanol inlet pipe and a methanol return pipe. The methanol pump strainer and the methanol level gauge are installed inside the methanol tank, and the methanol flows through the methanol pump strainer, the electric methanol pump, the methanol filter and the methanol pressure regulating valve successively, then goes through the methanol inlet pipe to the methanol distribution pipe and the methanol nozzle, and the methanol pressure regulating valve and the methanol tank are connected through the methanol return pipe.

Another technical solution which is employed in the present invention is as follows.

A control method for the diesel methanol combination combustion engine based on above-mentioned diesel methanol combination combustion engine, specifically, includes the following steps:

Step 1: starting the diesel engine in a pure diesel combustion mode;
Step 2: combusting in a pure diesel combustion mode;
Step 3: communicating the CAN interface of the methanol ECU and the OBD system of the vehicle, acquiring parameters from the CAN messages from diesel engine;
Step 4: according to the acquired parameters, determining whether all the following conditions are met by the methanol ECU, which are:

Condition 1: whether the methanol supply system meets the following terms, that is, whether the methanol pressure reaches the preset value and whether the methanol level is above the lower limit value;

Condition 2: whether the temperature of the engine cooling water is higher than or equal to the preset threshold, that is, whether the temperature of the engine cooling water reaches 60° C.;

Condition 3: whether the engine has not reached the full-load range, that is, whether the accelerator pedal is at the 100% operating point or not;

Condition 4: whether the engine has separated from the part below the no-load accelerator oblique line, that is, whether the engine is disconnected from the transmission.

If all of the above conditions are met, go to Step 4, otherwise, return to Step 2;

Step 5: implementing the diesel methanol combined combustion by injecting methanol.

Further, the method of determining the methanol injection volume by the methanol injection system is as follows:

step 5-1: obtaining the engine operating condition information, determining the basic value of target methanol injection volume by combining the obtained engine operating condition information with methanol MAP;

step 5-2: correcting the basic value of target methanol injection volume according to the influence of the temperature of the cooling water on the operating conditions of the diesel methanol combined combustion engine;

step 5-3: comparing the corrected basic value with the maximum methanol injection volume at the current engine speed, and taking the minimum value as the final methanol injection volume;

step 5-4: using the methanol injection volume and the methanol MAP, determining the driving pulse width of solenoid valve, outputting it to the methanol nozzle, and completing the control of the methanol injection volume by the nozzle solenoid valve.

Further, the interpolation method of methanol MAP in step 4-1 is as follows:

One dimension of methanol MAP is engine speed n, the other dimension is accelerator pedal opening α. There are 5 points in the MAP grid, wherein points 1-4 are two-dimensional data points determined in the bench calibration test, point 5 represents the operating condition point, and every point has one methanol controlled injection volume m corresponding to the specific engine speed n and accelerator opening α, i.e., at point 1, the engine speed value is n₁, the accelerator opening value is α₁, the methanol controlled injection volume value is m₁; at point 2, the engine speed value is n₂, the accelerator opening value is α₂, the methanol controlled injection volume value is m₂; at point 3, the engine speed value is n₃, the accelerator opening value is α₃, the methanol controlled injection volume value is m₃; at point 4, the engine speed value is n₄, the accelerator opening value is α₄, the methanol controlled injection volume value is m₄; at point 5, and the engine speed value is n₅, the accelerator opening value is α₅, the methanol controlled injection volume value is m₅. Intermediate points 5′ and 5″ are introduced to make it easy to understand the process of interpolation and the description of formula, and corresponding methanol injection volume values are m₅′ and m₅″, respectively.

Firstly, determining the MAP grid area where the engine operating condition point 5 is located, that is, determining four calibrated MAP points which are closed to the current engine speed n₅ and the accelerator opening α₅;

then, interpolating the values along the direction of the accelerator opening values α₁ and α₂, and obtain the methanol controlled injection volume m₅′, the specific calculation formula is as follows:

$${m}_{5}^{′} = \frac{{m}_{3} ( {α}_{3} - {α}_{4} ) + {m}_{4} ( {α}_{3} - {α}_{5} )}{( {α}_{3} - {α}_{4} )}$$

After completing the interpolation of the value m₅′, interpolating the values along the direction of the accelerator opening values α₃ and α₃ so as to obtain the value m₅″, the specific calculation formula is as follows:

$${m}_{5}^{″} = \frac{{m}_{3} ( {α}_{5} - {α}_{4} ) + {m}_{4} ( {α}_{3} - {α}_{5} )}{( {α}_{3} - {α}_{4} )}$$

After the above calculation, the methanol controlled volume value m₅ at the engine operating condition point 5 has not been obtained, which further requiring interpolation along the direction of the engine speed values n₁ and n₄, thus obtaining the result of the value m₅ finally. The calculation formula is as follows:

$${m}_{5} = \frac{{m}_{5}^{′} ( {n}_{4} - {n}_{5} ) + {m}_{5}^{″} ( {n}_{5} - {n}_{1} )}{( {n}_{4} - {n}_{1} )}$$

The methanol controlled injection volume value m₅ is obtained after three times of interpolation, which corresponding to the engine operating condition point 5 (n₅, α₅).

Further, carbon particles in the DPF are oxidized relying on nitrogen dioxide with a higher concentration in exhaust gas by a strategy of passive regeneration for the DPF in the post-processor assembly. In the case of large differential pressure between front and back of the DPF, methanol is injected through the methanol injector arranged on the exhaust pipe for combustion oxidation of captured carbon particles inside the DPF, and finally connected with the DOC for oxidation of unburned hydrocarbon and carbon monoxide.

Compared to the prior art, the beneficial effects of the present invention are as follows:

1. The engine of the present invention operates in the diesel methanol combined combustion mode, in which in-cylinder working fuel includes not only direct injection diesel fuel, but also methanol fuel. The output power of the engine is increased with the work done by the methanol fuel, which makes the driver reduces the depth of the accelerator pedal passively, thereby reduces the volume of diesel injection, and finally enabling the engine output power to meet the needs of the vehicle and achieve the purpose of reducing diesel consumption.

2. The present invention combines the advantages of the diesel methanol combined combustion engine, which is cleaner than traditional diesel engine, and can reduce the emission of NOx and soot simultaneously.

3. The diesel methanol combined combustion engine is equipped with the post-processor combination including thee methanol SCR, the DPF and the DOC. The reductant for the methanol specific SCR is the incomplete combustion products (including methanol) formed by methanol at high temperature. The urea SCR is eliminated, which can save the cost of using urea.

4. The diesel methanol combined combustion engine can operate in DMCC mode or pure diesel mode. The working mode can be switched and the application scenario is flexible.

### BRIEF DESCRIPTION OF THE DRAWINGS

FIG. 1 is a comparison of heat release rates between pure diesel mode and DMCC mode, in which, the horizontal ordinate represents the crank angle in degrees, and the longitudinal coordinate represents the cylinder pressure in MPa.

FIG. 2 is a comparison of temperature equivalence ratio distribution in the master heat release cylinder between pure diesel mode and DMCC mode, in which, the horizontal ordinate represents the cylinder temperature, and the longitudinal coordinate represents the local equivalence ratio.

FIG. 3 is a control flow chart of diesel methanol combined combustion engine according to the present invention.

FIG. 4 is a chart of local connection relation in the system in the embodiment according to the present invention.

FIG. 5 is a schematic diagram of methanol injection volume control strategy.

FIG. 6 is a schematic diagram of MAP network structure.

FIG. 7 is the control flow of methanol MAP correction in the embodiment according to the present invention.

FIG. 8 is a diagram of methanol supply system.

FIG. 9 is a diagram of post-processing system connection relation.

### DETAILED DESCRIPTION OF THE PRESENT INVENTION

In order to make the purpose, technical solutions, beneficial effects, and significant progress of the present invention clearer, the technical solutions in the embodiments of the present invention will be described clearly and completely in conjunction with the accompanying drawings provided in the embodiments of the present invention. Obviously, all the described embodiments are only part of the embodiments of the present invention, rather than all the embodiments.

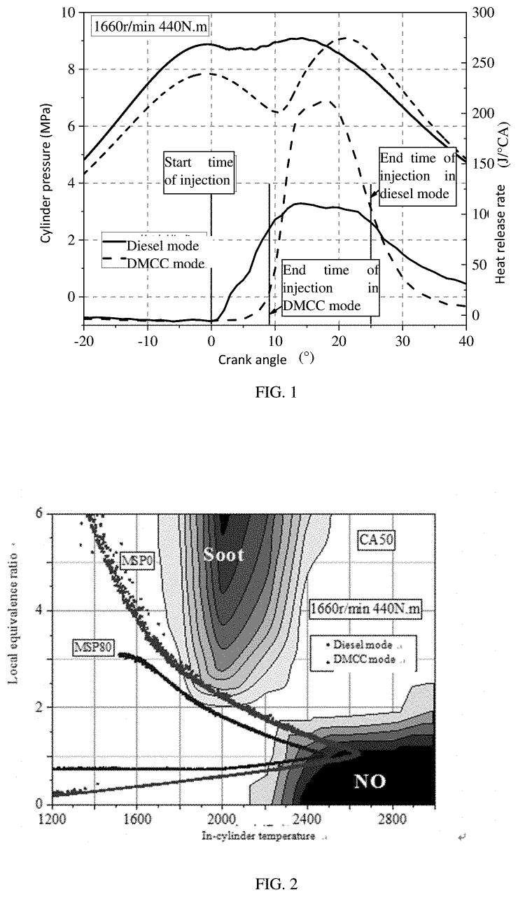

The diesel methanol combined combustion (DMCC) technology can achieve high efficiency combustion of the diesel engine, in particular, improving the thermal efficiency of engines especially under medium and full load conditions, which is determined by the physical and chemical properties of methanol. Methanol has high latent heat of vaporization. In the process of methanol injection into the inlet pipe to form a homogeneous mixture, the vaporization of methanol will absorb a lot of heat, which will result in substantial reduction of the temperature in the cylinder, thus extending the ignition delay period of diesel oil. A long ignition delay period of diesel oil will allow a long enough time for diesel oil to be fully atomized and to form highly active combustible mixture with methanol-air mixture. This part of combustible mixture will be simultaneously ignited in a homogeneous compression ignition mode when the in-cylinder boundary condition meets the ignition condition of this part of combustible mixture. This combustion mode greatly increased the proportion of constant pressure combustion; meanwhile the combustion duration of this combustion mode was short. The in-cylinder temperature was obviously lower in the later stage of power stroke, thus reducing the heat loss effectively and improving the thermal efficiency of the engine. FIG. 1 shows a comparison of cylinder pressure and heat release rate between pure diesel mode and DMCC mode, wherein, the in-cylinder pressure in the DMCC mode in the compression stroke was significantly lower than that in the pure diesel mode, which greatly reduced the negative work of compression. When the piston reached to the top dead center, a combustion exothermic reaction began to occur in the pure diesel mode, making the in-cylinder pressure rise continuously. However, according to the piston motion law, the rate of volumetric change in the cylinder is smaller without transition of higher pressure to effective output work. When the piston started to go down, the pressure in the cylinder was significantly reduced because combustion occurs 10 degree of crank angle following the top dead center (hereinafter referred to as TDC) in the dual-fuel mode. However, after the start of combustion, the cylinder pressure increases rapidly, the maximum cylinder pressure is close to that in the pure diesel mode, but meanwhile, the in-cylinder rate of volumetric change is higher to allow transition of higher pressure to effective output work. The cylinder pressure in the dual-fuel mode is obviously higher than that in the pure diesel mode after the start of combustion. However, after the piston moves to 40 degree of crank angle after TDC, the cylinder pressure in the dual-fuel mode is lower than that in the pure diesel mode because the combustion duration in the dual fuel mode is short, with less afterburning, the heat loss increases with the higher afterburning ratio, which will also increase the energy taken away by exhaust gas. Thus, the high efficiency combustion mechanism of diesel methanol combined combustion technology is as follows: the high latent heat of methanol vaporization and the inhibitory effect on low temperature ignition of diesel fuel extend the ignition delay period of diesel oil so that the diesel fuel is fully mixed with methanol-air mixture to realize homogeneous compression ignition combustion, which is the high efficiency combustion mechanism of diesel methanol combined combustion technology. The reduction of compression stroke pressure, the reduction of heat loss in the later stage of power stroke, the reduction of exhaust loss and the recovery of waste heat form methanol evaporation and atomization are the key factors of the thermal efficiency of DMCC technology.

The DMCC technology can reduce both NOx and soot emissions effectively. FIG. 2 is a comparison of temperature equivalence ratio distribution in the master heat release cylinder between pure diesel mode and DMCC mode, wherein, the DMCC mode avoided the soot generation region completely, and had no intersection with the area with a higher NO production zone, which is also the key to reduction of NOx emission. The main reasons for reduction of soot emission in the DMCC model are as follows: the local equivalence ratio can be effectively reduced by methanol premixing; the high oxygen content ratio of methanol makes methanol producing no soot during combustion; the extended ignition delay period of diesel oil reduces the local equivalence ratio of diesel oil. The reasons for reduction of NOx emission in the DMCC mode are as follows: the cylinder temperature was decreased by the high latent heat of methanol vaporization so as to realize low temperature combustion; the high proportion premixing of methanol made the heat release area more uniform, thus narrowing local high temperature areas; methanol was burnt at high speed so that the duration of combustion at high temperature was shortened, thus reducing NOx emission production.

### Embodiment

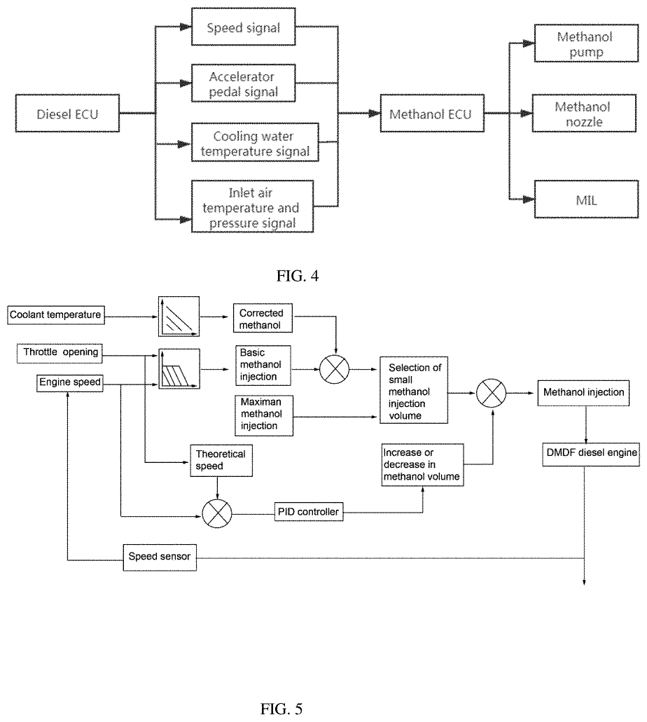

For the diesel engine equipped with the high pressure common-rail ECU, the high pressure common-rail ECU supports the communication by Controllable Area Net (CAN). When additionally installing the diesel methanol combined combustion engine in the vehicle, it is not necessary to install the sensors such as an accelerator position sensor, a water temperature sensor, a speed sensor or a methanol level sensor, the specific schematic diagram of the present invention is shown in FIG. 4.

A DMCC engine, comprising: a diesel engine that can only use diesel fuel, the diesel fuel adopts direct injection in cylinder, the diesel engine also includes: a methanol injection system which is provided on an inlet pipe of the diesel engine, a methanol ECU connected to the methanol injection system, a methanol supply system, a post-processor combination, and a methanol injector arranged inside the exhaust pipe of the diesel engine; the methanol injection system is composed of a methanol nozzle and a methanol injector.

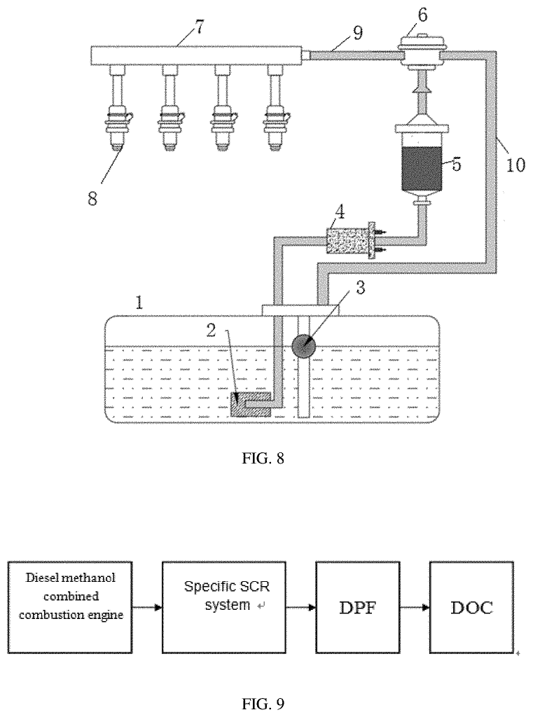

The methanol supply system, as shown in FIG. 8, mainly comprises a methanol tank, a methanol pump strainer, a methanol level gauge, an electric methanol pump, a methanol filter, a methanol pressure regulating valve, a methanol distribution pipe, a methanol inlet pipe and a methanol return pipe.

The methanol supply system, comprising: the methanol tank 1, the methanol pump strainer 2, the methanol level gauge 3, the electric methanol pump 4, the methanol filter 5, the methanol pressure regulating valve 6, the methanol distribution pipe 7, the methanol inlet pipe 9 and the methanol return pipe 10; the methanol pump strainer 2 and the methanol level gauge 3 are installed inside the methanol tank 1. The methanol flows through the methanol pump strainer 2, the electric methanol pump 4, the methanol filter 5 and the methanol pressure regulating valve 6, then goes through the alcohol inlet pipe 9 to the methanol distribution pipe 9 and a methanol nozzle 8, and the alcohol pressure regulating valve 6 and the methanol tank 1 are connected through the methanol return pipe 10.

Due to the corrosive action of methanol on some materials, methanol-related components should be made of stainless steel. Electro-hydraulic separation should be designed in the methanol supply system of the present invention, and the methanol-related components should be made of stainless steel in order to avoid electrochemical corrosion. Both the methanol inlet pipe and the methanol return pipe are rubber pipes in the methanol supply system, and methanol resistant rubber is selected instead of normal rubber, preferably, rubber is one selected from the group consisting of high fluorine rubber, nitrile rubber, silicon rubber, PTEF and chloroprene rubber. The methanol level gauge should also be made of stainless steel.

FIG. 9 is a diagram of ultra-low-emission post-processing system of diesel methanol combined combustion technology. It can be seen from FIG. 9 that the traditional engine was in connection with methanol specific SCR system, and the reductant for the methanol specific SCR was the incomplete combustion products (including methanol) formed by methanol at high temperature. Then the engine was connected with the DPF which adopts the strategy of passive regeneration under most operating conditions. Nitrogen dioxide in the exhaust gas oxidizes the carbon particles captured in the DPF. If the pressure difference between front and back of the DPF is large, methanol should be injected in the exhaust pipe for combustion oxidation of captured carbon particles inside DPF. Finally, the engine is connected with the DOC to oxidize unburned hydrocarbon and carbon monoxide.

The methanol ECU acquires parameters from the CAN messages of the high pressure common-rail ECU, the parameters includes speed signal, accelerator pedal signal, cooling water temperature signal, and inlet temperature and pressure signal. The speed and accelerator pedal signals are used to interpolate the methanol MAP, and the water temperature signal and inlet air temperature and pressure signals are used to correct the methanol MAP. As shown in FIG. 7, the methanol ECU controls the on-off of the methanol pump and the power-on time of the methanol injector.

The calculation formula of correction of cooling water temperature to methanol MAP is as follows:

MI=MI1×(1+f_{Tw})

Wherein, MI is the target methanol injection width, MI1 is the basic methanol injection width; f_{Tw} is the correction coefficient of cooling water temperature.

The calculation formula of correction coefficients of cooling water temperature is as follows:

f_{Tw}=0.3×(T_{w}−T_{w0})/(T_{wh}−T_{w0})−0.3

Wherein, T_{w} is the current value of cooling water temperature, T_{wh} is the preset high value of the cooling water temperature, T_{w0} is the preset cooling water temperature threshold whether methanol is sprayed or not.

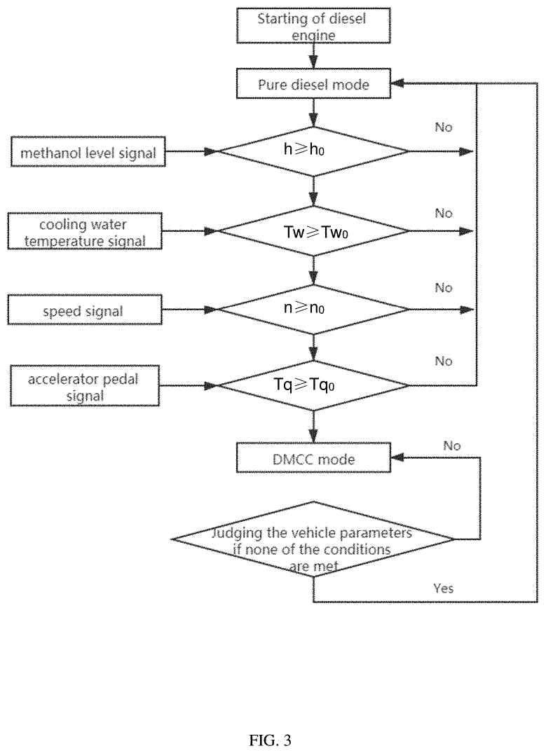

The diagram of mode switch of DMCC technology is shown in FIG. 3. The working principle of DMCC technology was started in the pure diesel mode. The engine entered the dual-fuel operating mode when the water temperature of engine reached the preset cooling water temperature, and the premixed methanol mixture was ignited by diesel fuel. As shown in FIG. 3, several conditions should be judged for switching from pure diesel mode to DMCC mode, including methanol level, water temperature, speed and accelerator pedal, wherein the set water temperature is 60° C., and the engine may be switched to the DMCC operating mode when the coolant temperature reached or exceeded 60° C. In order to achieve high efficiency and safe combustion in the DMCC mode, methanol did not participate in the work below the no-load accelerator oblique line and in the full accelerator range, wherein the part below the no-load accelerator oblique line is the small-load operating range of the engine, if methanol participates in combustion within this range, the combustion efficiency will be reduced; meanwhile, methanol injection can cause fuel waste due to no power output in this range. The maximum cylinder pressure and the maximum pressure rise rate will exceed the limit if methanol is added in the full-load range, which may cause damage to the engine. Therefore, methanol does not participate in combustion in the full accelerator range.

As shown in FIG. 3, the engine control method includes the following steps of:

Step 1: starting the diesel engine in a pure diesel combustion mode;
Step 2: combusting in a pure diesel combustion mode;
Step 3: determining whether all the following conditions are met, which are:

Condition 1: whether the methanol supply system meets the following terms, that is, whether the methanol pressure reaches the preset value and whether the methanol level is above the lower limit value;

Condition 2: whether the temperature of the engine cooling water is higher than or equal to the preset threshold, that is, whether the temperature of the engine cooling water reaches 60° C.;

Condition 3: whether the engine has not reached the full-load range, that is, whether the accelerator pedal is at the 100% operating point or not;

Condition 4: whether the engine has separated from the part below the no-load accelerator oblique line, that is, whether the engine is disconnected from the transmission.

If all of the above conditions are met, go to Step 4, otherwise, return to Step 2;

Step 4: implementing the diesel methanol combined combustion by injecting methanol.

In the diesel methanol combined combustion mode:

When all the preset conditions are met, methanol was injected into the inlet pipe close to manifold of engine continuously, then a homogeneous mixture was formed with the air in the inlet pipe and supplied into the cylinder through manifold. In-cylinder working fuel will include not only direct injection diesel fuel, but also methanol fuel. The output power of the engine was increased with the work done by the methanol fuel, which made the driver reduce the depth of the accelerator pedal passively, thereby reducing the volume of diesel injection, and finally enabling the engine output power to meet the needs of the vehicle and achieve the purpose of reducing diesel consumption.

In terms of the diesel methanol combined combustion technology, the methanol injection volume value is the core of controlling the diesel methanol combined combustion. The methanol injection volume of the methanol injection system is that for the cylinders per cycle when the diesel engine operates in the diesel methanol combined combustion mode. For the DMCC engine, the methanol injection volume is the most basic and most important parameter. Effective control of each methanol injection volume needs to be realized under different operating conditions, which are, how much methanol injection volume is needed and how to achieve the target. The methanol injection volume mainly depends on two factors: one is the methanol injection pressure and the other is the opening time of methanol injector. In fact, the system controls the methanol injection pressure to be a constant value relying on the pressure regulating valve, and the methanol injection volume is basically proportional to the duration of injection each time. The driving pulse width of the nozzle is determined by inquiring the basic methanol injection volume through the MAP, which is realized by the nozzle solenoid valve.

As shown in FIG. 5, the method of determining the methanol injection volume by the methanol injection system is as follows

step 4-1: obtaining the engine operating condition information, determining the basic value of target methanol injection volume by combining the obtained engine operating condition information with methanol MAP;

step 4-2: correcting the basic value of target methanol injection volume according to the influence of the temperature of the cooling water on the operating conditions of the diesel methanol combined combustion engine;

step 4-3: comparing the corrected basic value with the maximum methanol injection volume at the current engine speed, and taking the minimum value as the final methanol injection volume;

step 4-4: using the obtained methanol injection volume and the obtained methanol MAP, determining the driving pulse width of solenoid valve, outputting it to the methanol nozzle, and completing the control of the methanol injection volume by the nozzle solenoid valve.

The interpolation method of methanol MAP in the step 4-1 is as follows:

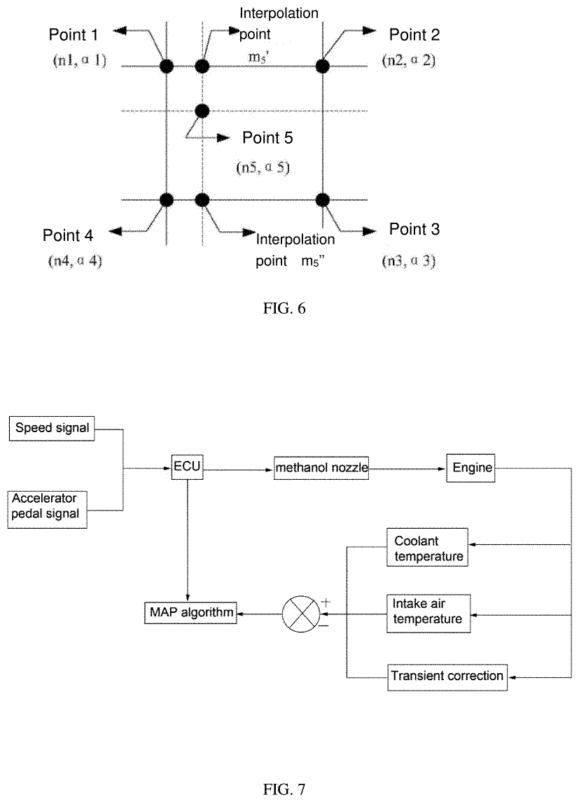

One dimension of methanol MAP is engine speed n, the other dimension is accelerator pedal opening α, and the most important concept in this method is grid; as shown in FIG. 6, there are 5 points in the MAP grid, wherein points 1-4 are two-dimensional data points determined in the bench calibration test, point 5 represents the operating condition point, and every point has one methanol controlled injection volume m corresponding to the specific engine speed n and accelerator opening α, i.e., at point 1, the engine speed is n₁, the accelerator opening is α₁, the methanol controlled injection volume value is m₁; at point 2, the engine speed is n₂, the accelerator opening is α₂, the methanol controlled injection volume value is m₂; at point 3, the engine speed is n₃, the accelerator opening is α₃, the methanol controlled injection volume is m₃; at point 4, the engine speed is n₄, the accelerator opening is α₄, the methanol controlled injection volume is m₄; and at point 5, the engine speed is n₅, the accelerator opening is α₅, the methanol controlled injection volume is m₅. Intermediate point 5′ and 5″ are introduced to make it easy to understand the process of interpolation and the description of formula, and corresponding methanol injection volume values are m₅′ and m₅″, respectively.

Firstly, determining the MAP grid area where the engine operating condition point 5 is located, that is, determining four calibrated MAP points which are closed to the current engine speed n₅ and accelerator opening α₅.

Then, interpolating the values according to the direction of accelerator opening α₁ and α₂, and obtain the methanol controlled injection volume value m₅′, the specific calculation formula is as follows:

$${m}_{5}^{′} = \frac{{m}_{3} ( {α}_{3} - {α}_{4} ) + {m}_{4} ( {α}_{3} - {α}_{5} )}{( {α}_{3} - {α}_{4} )}$$

After completing the interpolation of the value m₅′, interpolating the values along the direction of accelerator opening α₃ and α₃, and obtain the value m₅″, the specific calculation formula is as follows:

$${m}_{5}^{″} = \frac{{m}_{3} ( {α}_{5} - {α}_{4} ) + {m}_{4} ( {α}_{3} - {α}_{5} )}{( {α}_{3} - {α}_{4} )}$$

After above calculation, the methanol controlled volume value m₅ at engine operating condition point 5 has not been obtained, which further requiring interpolation along the direction of engine speed n₁ and n₄, the result of the value m₅ is obtained finally. The calculation formula is as follows:

$${m}_{5} = \frac{{m}_{5}^{′} ( {n}_{4} - {n}_{5} ) + {m}_{5}^{″} ( {n}_{5} - {n}_{1} )}{( {n}_{4} - {n}_{1} )}$$

The methanol controlled injection volume m₅ is obtained after three times of interpolation, which corresponding to engine operating condition point 5 (n₅, α₅).

Carbon particles in DPF are oxidized relying on nitrogen dioxide with a higher concentration in exhaust gas by a strategy of passive regeneration for DPF in the post-processor assembly. In the case of large differential pressure between front and back of DPF, methanol is injected through the methanol injector arranged on the exhaust pipe for combustion oxidation of captured carbon particles inside DPF, and finally connected with DOC for oxidation of unburned hydrocarbon and carbon monoxide.

The above descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A diesel methanol combined combustion (DMCC) engine, includes a diesel engine and post-processor combination; the post-processor combination includes: a methanol specific SCR system, a diesel particulate filter (DPF) and a diesel oxidation-catalytic converter (DOC); the methanol specific SCR system and the DPF are controlled by a methanol electronic control unit; the post-processor combination is installed on an exhaust pipe of the diesel engine, and the connection sequence of the post-processor combination on the exhaust pipe is the methanol specific SCR system, the DPF and the DOC sequentially;
wherein, the diesel engine is equipped with a high pressure common-rail electronic control unit (ECU), the diesel methanol combined combustion (DMCC) engine also includes: a methanol injection system, a methanol electronic control unit (hereinafter referred to as ECU), a methanol supply system;
the methanol ECU and the methanol supply system are respectively connected with the methanol injection system;
the methanol ECU is connected to the methanol injection system, the methanol ECU is provided with an CAN interface, which is connectable to the high pressure common-rail ECU of the diesel engine, so that the methanol ECU acquires parameters from the CAN messages of the high pressure common-rail ECU; the methanol ECU calculates methanol injection volume according to working condition of the diesel engine, the methanol supply system continuously supplies methanol at a certain pressure to the methanol injection system; wherein the acquired parameter includes speed signal, accelerator pedal signal, cooling water temperature signal, and inlet temperature and pressure signal;
the methanol injection system is installed on an intake pipe of the diesel engine after the engine intercooler, and the methanol injection system is composed of a methanol nozzle and a methanol injector;
wherein the methanol supply system comprises the methanol tank, a methanol pump strainer, a methanol level gauge, an electric methanol pump, a methanol filter, a methanol pressure regulating valve, a methanol distribution pipe, a methanol inlet pipe and a methanol return pipe; the methanol pump strainer and the methanol level gauge are installed inside the methanol tank; the methanol flowing through the methanol pump strainer, the electric methanol pump, the methanol filter and the methanol pressure regulating valve successively, then going through the methanol inlet pipe to the methanol distribution pipe and the methanol nozzle, and the methanol pressure regulating valve and the methanol tank are connected through the methanol return pipe.

2. A control method of diesel methanol combined combustion engine based on the diesel methanol combination combustion engine mentioned according to claim 1, wherein the control method comprises the following steps:
Step 1: starting the diesel engine in a pure diesel combustion mode;
Step 2: combusting in a pure diesel combustion mode;
Step 3: communicating the CAN interface of the methanol ECU and the OBD system of the vehicle, acquiring parameters from the CAN messages from diesel engine;
Step 4: according to the acquired parameters, determining whether all the following conditions are met by the methanol ECU, which are:
Condition 1: whether the methanol supply system meets the following terms, that is, whether the methanol pressure reaches the preset value and whether the methanol level is above the lower limit value;
Condition 2: whether the temperature of the engine cooling water is higher than or equal to the preset threshold, that is, whether the temperature of the engine cooling water reaches 60° C.;
Condition 3: whether the engine has not reached the full-load range, that is, whether the accelerator pedal is at the 100% operating point or not;
Condition 4: whether the engine has separated from the part below the no-load accelerator oblique line, that is, whether the engine is disconnected from the transmission;
if all of the above conditions are met, turn to Step 4, otherwise, return to Step 2;
Step 5: implementing the diesel methanol combined combustion by injecting methanol.

3. The control method of diesel methanol combined combustion engine according to claim 2, wherein the method of determining the methanol injection volume by the methanol injection system is as follows:
Step 5-1: obtaining the engine operating condition information, determining the basic value of target methanol injection volume by combining the obtained engine operating condition information with methanol MAP;
step 5-2: correcting the basic value of target methanol injection volume according to the influence of the temperature of the cooling water on the operating conditions of the diesel methanol combined combustion engine;
step 5-3: comparing the corrected basic value with the maximum methanol injection volume at the current engine speed, and taking the minimum value as the final methanol injection volume;
step 5-4: using the methanol injection volume and the methanol MAP, determining the driving pulse width of solenoid valve, outputting it to the methanol nozzle, and completing the control of the methanol injection volume by the nozzle solenoid valve.

4. The control method of diesel methanol combined combustion engine according to claim 2, wherein the interpolation method of the methanol MAP in step 5-1 is as follows:
one dimension of methanol MAP is engine speed n, the other dimension is accelerator pedal opening α; there are 5 points in the MAP grid, wherein points 1-4 are two-dimensional data points determined in the bench calibration test, point 5 represents the operating condition point, and every point has one methanol controlled injection volume value m corresponding to the specific engine speed value n and accelerator opening value α, i.e., at point 1, the engine speed value is n₁, the accelerator opening value is α₁, the methanol controlled injection volume value is m₁; at point 2, the engine speed value is n₂, the accelerator opening value is α₂, the methanol controlled injection volume value is m₂; at point 3, the engine speed value is n₃, the accelerator opening value is α₃, the methanol controlled injection volume value is m₃; at point 4, the engine speed value is n₄, the accelerator opening value is α₄, the methanol controlled injection volume value is m₄; at point 5, and the engine speed value is n₅, the accelerator opening value is α₅, the methanol controlled injection volume value is m₅; intermediate points 5′ and 5″ are introduced to make it easy to understand the process of interpolation and the description of formula, and corresponding methanol injection volume values are m₅′ and m₅″, respectively;
firstly, determining the MAP grid area where the engine operating condition point 5 is located, that is, determining four calibrated MAP points which are closed to the current engine speed value n₅ and the accelerator opening value α₅;
then, interpolating the values along the direction of the accelerator opening values α₁ and α₂, and obtaining the methanol controlled injection volume value m₅′, the specific calculation formula is as follows:
$${m}_{5}^{′} = \frac{{m}_{3} ( {α}_{3} - {α}_{4} ) + {m}_{4} ( {α}_{3} - {α}_{5} )}{( {α}_{3} - {α}_{4} )}$$
after completing the interpolation of the value m₅′, interpolating the values along the direction of the accelerator opening values α₃ and α₃ so as to obtain the value m₅″, the specific calculation formula is as follows:
$${m}_{5}^{″} = \frac{{m}_{3} ( {α}_{5} - {α}_{4} ) + {m}_{4} ( {α}_{3} - {α}_{5} )}{( {α}_{3} - {α}_{4} )}$$
after above calculation, the methanol controlled volume value m₅ at the engine operating condition point 5 has not been obtained, which further requiring interpolation along the direction of the engine speed values n₁ and n₄, thus obtaining the result of value m₅ finally; the calculation formula is as follows:
$${m}_{5} = \frac{{m}_{5}^{′} ( {n}_{4} - {n}_{5} ) + {m}_{5}^{″} ( {n}_{5} - {n}_{1} )}{( {n}_{4} - {n}_{1} )}$$
the methanol controlled injection volume value m₅ is obtained after three times of interpolation, which corresponding to the engine operating condition point 5 (n₅, α₅).
